(19) United States
(12) Patent Application Publication
(10) Pub. No.: US 2025/0229680 A1
(43) Pub. Date: Jul. 17, 2025

(54) VEHICLE

(71) Applicant: TOYOTA JIDOSHA KABUSHIKI KAISHA, Toyota-shi (JP)

(72) Inventors: Naohiro SAITO, Toyota-shi (JP); Hisashi JUFUKU, Seto-shi (JP)

(21) Appl. No.: 18/946,930

(22) Filed: Nov. 14, 2024

(30) Foreign Application Priority Data
Jan. 12, 2024 (JP) 2024-003385

(51) Int. Cl. B60N 2/56; B60H 1/00; B60H 1/22

(52) U.S. Cl. CPC B60N 2/5657; B60H 1/00285; B60H 1/00742; B60H 1/2218; B60N 2/5685; B60H 2001/003; B60H 2001/224

(57) ABSTRACT

A vehicle including: a vehicle seat that have, at a surface thereof, a hole communicating with an interior thereof, an occupant being able to sit at the vehicle seat; seat ventilation configured to suck air into the interior of the vehicle seat; an air conditioning section configured to discharge warm air or cold air into a vehicle cabin to adjust a temperature within the vehicle cabin; a receiving section configured to receive an operation instruction for heating by the air conditioning section prior to boarding by the occupant; and a drive control section, in a case in which the operation instruction for heating has been received, configured to cause warm air to be discharged into the vehicle cabin by the air conditioning section, and to cause the warm air to be sucked in by the seat ventilation.

### CROSS-REFERENCE TO RELATED APPLICATION

This application is based on and claims priority under 35 USC 119 from Japanese Patent Application No. 2024-003385, filed on Jan. 12, 2024, the entire disclosure of which is incorporated by reference herein.

### BACKGROUND

### Technical Field

The present disclosure relates to a vehicle installed with a vehicle seat including seat ventilation.

### Related Art

Japanese Patent Application Laid-Open (JP-A) No. 2022-020529 discloses a vehicle seat that respectively controls a seat heater and a seat ventilation mechanism based on cabin temperature information, solar radiation amount information, seat heater temperature information, and pad humidity information, when an occupant is recognized as being seated at a seat cushion according to an image captured by a camera.

In the vehicle seat described in Japanese Patent Application Laid-Open (JP-A) No. 2022-020529, there are cases in which heat is transferred from a seatback side to a seat cushion side or is transferred to a seat interior, when the occupant is seated, whereby a temperature of the vehicle seat is lowered, and comfort of the occupant is reduced.

### SUMMARY

The present disclosure has been made in consideration of such circumstances, and an object of the present disclosure is to provide a vehicle that is capable of suppressing reduction in comfort of an occupant when seated at a vehicle seat.

A vehicle according to a first aspect of the present disclosure includes: a vehicle seat that has, at a surface thereof, a hole communicating with an interior thereof, and at which an occupant sits; seat ventilation that sucks air into the interior of the vehicle seat; an air conditioning section that discharges warm air or cold air into a vehicle cabin to adjust a temperature within the vehicle cabin; a receiving section that receives an operation instruction for heating by the air conditioning section prior to boarding by the occupant; and a drive control section that, in a case in which the operation instruction for heating has been received, causes warm air to be discharged into the vehicle cabin by the air conditioning section, and causes the warm air to be sucked in by the seat ventilation.

In the vehicle according to the first aspect of the present disclosure, in a case in which the receiving section has received an operation instruction for heating by the air conditioning section prior to boarding by the occupant, the drive control section causes warm air to be discharged into the vehicle cabin by the air conditioning section, and causes warm air to be sucked in by the seat ventilation. Thus, the interior of the vehicle seat can be warmed by sucking in warm air resulting from heating, at the seat ventilation, prior to boarding by the occupant, and therefore, temperature reduction of the vehicle seat when the occupant is seated can be suppressed. Consequently, reduction in comfort of the occupant when seated at the vehicle seat can be suppressed.

A vehicle according to a second aspect of the present disclosure is the vehicle according to the first aspect, which includes a seat heater that warms a surface of the vehicle seat on a side at which the occupant sits, wherein, in a case in which boarding of the vehicle by the occupant has been detected, the drive control section switches from operation of the seat ventilation to operation of the seat heater.

In the vehicle according to the second aspect of the present disclosure, since the seat heater is operated when the occupant boards the vehicle, the vehicle seat is warmed by the seat heater, and therefore, comfort of the occupant when the occupant is seated at the vehicle seat can be further improved.

A vehicle according to a third aspect of the present disclosure is the vehicle according to the first aspect or the second aspect, which includes an electric register that is capable of electrically changing a wind direction of the warm air and the cold air, wherein, in a case in which the operation instruction for heating has been received, the drive control section controls the electric register such that the wind direction is directed toward the vehicle seat.

In the vehicle according to the third aspect of the present disclosure, in a case in which the receiving section has received operation instruction for heating by the air conditioning section prior to boarding by the occupant, the drive control section controls the electric register such that the wind direction of the warm air is directed toward the vehicle seat, and therefore, the interior of the vehicle seat can be warmed more efficiently.

A vehicle according to a fourth aspect of the present disclosure is the vehicle according to any one of the first aspect to the third aspect, wherein, in a case in which the operation instruction for heating has been received, the drive control section sets at least one of a blowing amount or a temperature of the air conditioning section to maximum.

In the vehicle according to the fourth aspect of the present disclosure, in a case in which the receiving section has received operation instruction for heating by the air conditioning section prior to boarding by the occupant, the drive control section sets at least one of the blowing amount or the temperature of the air conditioning section to maximum, and therefore, the interior of the vehicle seat can be warmed more efficiently.

A vehicle according to a fifth aspect of the present disclosure is the vehicle according to the fourth aspect, wherein, in a case in which boarding of the vehicle by the occupant has been detected, the drive control section returns the blowing amount and the temperature of the air conditioning section to normal.

In the vehicle according to the fifth aspect of the present disclosure, in a case in which boarding of the vehicle by the occupant has been detected, since the drive control section returns the blowing amount and the temperature of the warm air to normal, a setting operation by the occupant when the occupant has boarded can be made unnecessary, and an excessive blowing amount and an excessively high temperature can be prevented to thereby ensure comfort of the occupant.

The vehicle according to the present disclosure has an excellent advantageous effect in that reduction in comfort of an occupant when seated at a vehicle seat can be suppressed.

### BRIEF DESCRIPTION OF THE DRAWINGS

An embodiment of the present disclosure will be described in detail based on the following figures, wherein:

FIG. 1 is a side view schematically illustrating a vehicle seat installed at a vehicle according to an exemplary embodiment of the present disclosure;

FIG. 2 is a side view, partially in cross-section, schematically illustrating the vehicle seat installed at the vehicle according to the exemplary embodiment of the present disclosure;

FIG. 3 is a block diagram illustrating an example of a schematic configuration of the vehicle according to the exemplary embodiment of the present disclosure;

FIG. 4 is a block diagram illustrating an example of a functional configuration of a vehicle ECU according to the exemplary embodiment of the present disclosure;

FIG. 5 is a schematic diagram schematically illustrating reception of a heating request;

FIG. 6 is a schematic diagram schematically illustrating detection of an occupant;

FIG. 7 is a schematic diagram schematically illustrating unlocking of a door lock by an occupant; and

FIG. 8 is a flow chart illustrating a series of control processing in the vehicle ECU.

### DETAILED DESCRIPTION

A vehicle 10 according to an exemplary embodiment of the present disclosure will be explained below, with reference to the accompanying drawings. It should be noted that, in the present specification and drawings, constituent elements that have substantially the same functional configuration are appended with the same reference numerals, and duplicate explanation thereof is omitted. Further, in each of the drawings as appropriate, arrow UP, arrow FR, arrow LH, and arrow RH respectively indicate an upper direction, a front direction, and a left direction and a right direction (vehicle width direction) of a vehicle seat 20 installed at the vehicle.

In the present exemplary embodiment, as an example, the vehicle 10 is any vehicle from among a gasoline vehicle, a hybrid vehicle (hybrid electric vehicle (HEV)), a plug-in hybrid vehicle (plug-in hybrid electric vehicle (PHEV)), a fuel cell vehicle (fuel cell electric vehicle (FCEV)), an electric vehicle (battery electric vehicle (BEV)), or the like. Further, the vehicle seat 20 is installed at the vehicle 10.

### Configuration of Vehicle Seat 20

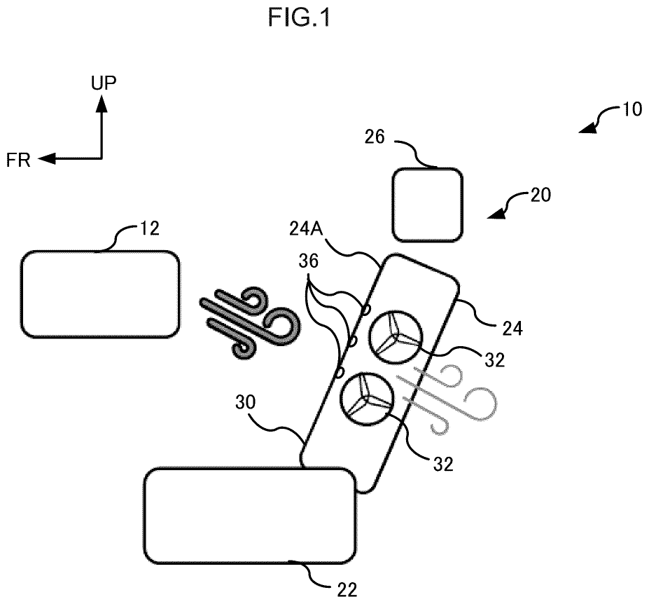

The vehicle seat 20 of the present exemplary embodiment is a seat installed at the vehicle 10, and, as illustrated in FIG. 1 as an example, includes a seat cushion 22 at which an occupant sits (supporting buttocks and thighs of the occupant), a seatback 24 that supports a back of the occupant, namely, configuring a backrest, and a headrest 26 that supports a head of the occupant.

The seat cushion 22 includes a cushion pad (not illustrated in the drawings), a seat pan (not illustrated in the drawings), and a seat skin (not illustrated in the drawings). The cushion pad configures a seat face portion of the vehicle seat 20, and is formed of, for example, a synthetic resin material having elasticity, such as polyurethane foam (foamed polyurethane), or the like. The occupant sits at a seat upper side (seat surface) of the seat cushion 22. The seat pan is a frame configuring a skeleton of the seat cushion 22. The seat skin is formed of a seat member having flexibility, such as cloth, leather, synthetic leather or the like.

The seatback 24 configures a backrest portion of the vehicle seat 20, and supports the back of the occupant seated at the seat cushion 22 at a seat front side (seat surface) of the seatback 24. The seatback 24 includes a seatback frame (not illustrated in the drawings), a seatback pad (not illustrated in the drawings), and a seat skin 30. Further, in the present exemplary embodiment, the seatback 24 includes seat ventilation 32 and a seat heater 34.

The seatback frame configures a skeleton of the seatback 24. The seatback pad is formed of, for example, a synthetic resin material having elasticity, such as polyurethane foam (foamed polyurethane), or the like.

The seat skin 30 has holes 36 communicating with an interior, at a surface thereof. Specifically, the seat skin is configured of a material having air permeability, such as, for example, a fabric (cloth), natural leather or synthetic leather having a large number of small holes, or the like. It should be noted that, in FIG. 1, the sizes and shapes of the holes 36 are illustrated in an exaggerated manner, but that the holes 36 are actually configured by smaller holes. Specifically, the holes 36 are, for example, holes configured by a mesh of a mesh-like material such as the fabric, or the like, or the aforementioned small holes in the natural leather or the synthetic leather, or the like.

The seat ventilation 32 is provided at an interior of the seatback 24 as an example, is configured by, for example, a fan, a blower, or the like, and is a device that sucks air into the interior of the seatback 24 through the holes 36 at the seat skin 30. The seat ventilation 32 is configured such that a blowing amount can be switched in a stepwise manner.

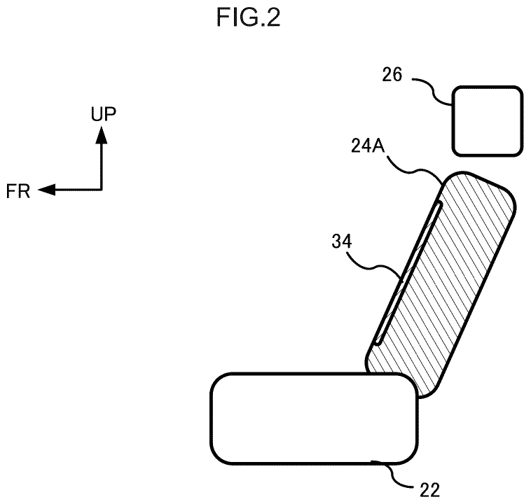

The seat heater 34 is an electric heater such as a positive temperature coefficient (PTC) heater or the like, and, as illustrated in FIG. 2, is a heating device that heats a side of the seatback 24, namely, a surface 24A at a front side thereof, at which the occupant is seated, utilizing heat generated by an electric current. As an example, the seat heater 34 is installed at a surface 24A side at the interior of the seatback 24, and is configured such that a heating output can be adjusted in a stepwise manner. It should be noted that, in the present exemplary embodiment, the seat heater 34 and the seat ventilation 32 are installed at different positions, namely, so as not to overlap with each other, in a front view.

### Configuration of Vehicle 10

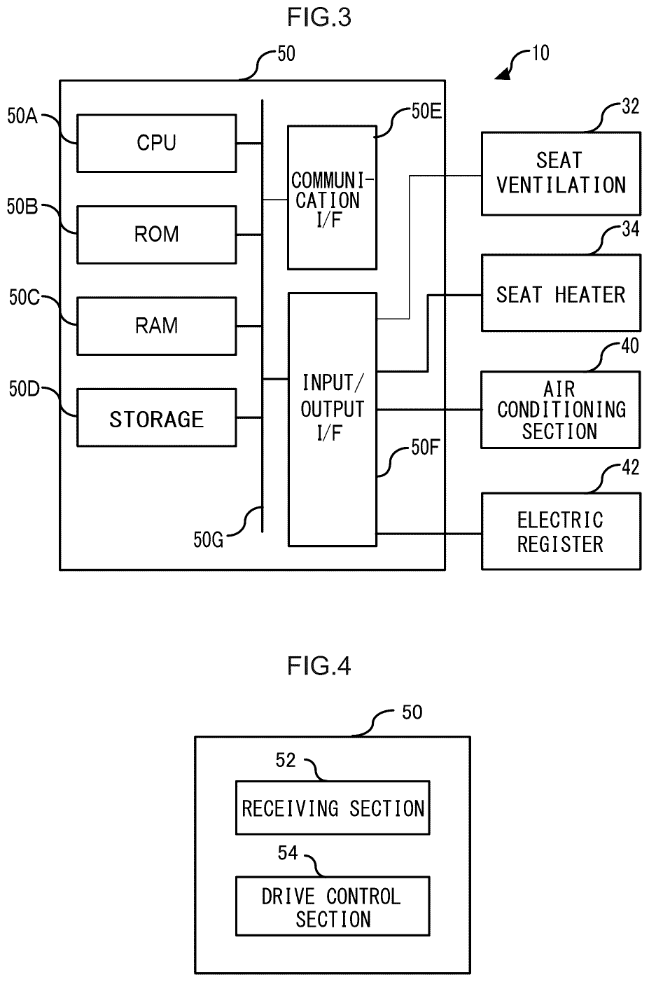

Next, a configuration of the vehicle 10 will be explained. As illustrated in FIG. 3, the vehicle 10 of the present exemplary embodiment includes a vehicle ECU 50, the seat ventilation 32, the seat heater 34, an air conditioning section 40, and an electric register 42.

The vehicle ECU 50 is configured to include a central processing unit (CPU; processor) 50A, a read only memory (ROM) 50B, a random access memory (RAM) 50C, a storage 50D, a communication interface (communication I/F) 50E, and an input/output interface (input/output I/F) 50F. Known technology is used for each configuration, and the respective configurations are connected so as to be capable of communicating with each other via a bus 50G.

The seat ventilation 32, the seat heater 34, the air conditioning section 40, the electric register 42, and the like that are described above are connected to the input/output I/F 50F.

The air conditioning section 40 is a device that discharges temperature-adjusted air, such as warm air, cold air or the like, into a vehicle cabin, to adjust a temperature within the vehicle cabin. In the present exemplary embodiment, the air conditioning section 40 is configured so as to be capable of adjusting a temperature of air to be discharged in a stepwise manner, and is also configured so as to be capable of adjusting a blowing amount of the air to be discharged in a stepwise manner. It should be noted that known technology such as an air conditioning unit or the like can be used as the air conditioning section 40, and therefore, detailed explanation thereof is omitted here.

As illustrated in FIG. 1 as an example, the air conditioning section 40 is installed at an inner side (a vehicle front side) of an instrument panel 12 provided at a vehicle cabin front portion of the vehicle 10. The vehicle seat 20, which is a seat at a front side (front seat), is provided at a vehicle rear side of the instrument panel 12. Further, an air ejection port (not illustrated in the drawings) for discharging air, whose temperature has been adjusted at the air conditioning section 40, toward an interior of the vehicle cabin is provided at an outer side (a vehicle rear side) of the instrument panel 12.

The electric register 42 is a device that is capable of electrically changing a wind direction of warm air and cold air. Specifically, as an example, the electric register 42 is provided at the air ejection port of the instrument panel 12, and includes a wind direction plate (not illustrated in the drawings) that is capable of changing the wind direction, and a motor that rotates the wind direction plate. In the present exemplary embodiment, as an example, the wind direction plate is configured with plural fins that are disposed in parallel in a vehicle up-down direction (vertical direction). The wind direction in the vehicle up-down direction is changed due to the plural fins being rotated about an axis along a vehicle width direction (a lateral direction) by the motor.

The vehicle ECU 50 realizes various functions using the aforementioned hardware resources. As illustrated in FIG. 4, the vehicle ECU 50 is configured to include, as functional configurations, a receiving section 52 and a drive control section 54. It should be noted that each functional configuration is realized due to the CPU 50A reading out and executing a program stored in the ROM 50B or the storage 50D.

Prior to boarding by the occupant, the receiving section 52 receives an operation instruction for heating by the air conditioning section 40. Specifically, as illustrated in FIG. 5 as an example, the receiving section 52 receives a heating request that has been transmitted by a portable terminal, such as a smartphone, or the like, via the communication I/F 50E.

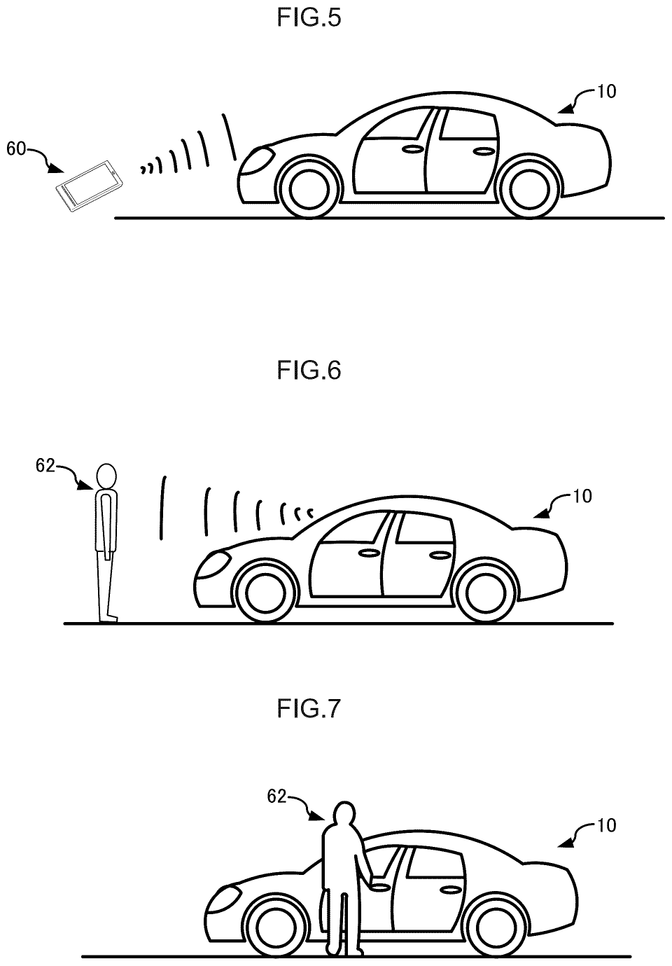

Further, as an example, the receiving section 52 of the present exemplary embodiment also functions as a detecting section that detects boarding of the vehicle 10 by the occupant. Specifically, as illustrated in FIG. 6, the receiving section 52 receives approaching signal of an occupant 62 who is holding a smart key corresponding to the vehicle 10, that is to say, approaching signal of the smart key, via the communication I/F 50E. It should be noted that the receiving section 52 detects boarding by the occupant 62 due to receiving a transmission signal that is transmitted from the smart key.

The receiving section 52 of the present exemplary embodiment receives the heating request carried out by wireless communication and the transmission signal that is transmitted from the smart key, at predetermined time intervals via the communication I/F 50E.

It should be noted that the function of the detecting section that detects the boarding of the vehicle 10 by the occupant is not limited to that which is described above. For example, the receiving section 52 may be configured so as to be capable of receiving signals indicating locking and unlocking of a door lock of the vehicle 10 from the communication I/F 50E or the input/output I/F 50F, and, as illustrated in FIG. 7, may be configured so as to detect boarding by the occupant 62 in a case in which the occupant 62 has unlocked the door lock of the vehicle 10. Further, for example, in a case in which the air conditioning section 40 includes a timer section that sets an operation time for heating when an operation instruction for heating has been received by the receiving section 52, a configuration my be provided such that boarding by the occupant 62 is detected due to the receiving section 52 receiving a signal from the timer section when a set time has elapsed since heating was actuated. In such a case, it is assumed that warming up of the interior of the vehicle cabin can be completed within the set time. Further, the vehicle 10 may be provided with a plurality of the aforementioned respective configurations.

When the receiving section 52 has received the operation instruction for heating, the drive control section 54 causes the air conditioning section 40 to discharge warm air into the vehicle cabin, and causes the seat ventilation 32 to suck in the discharged warm air. Specifically, the drive control section 54 sets a temperature of the air to be discharged by the air conditioning section 40 to warm air (a temperature higher than an air temperature within the vehicle cabin), and drives and controls the air conditioning section 40 such that air at the set temperature is discharged from the air ejection port. In the present exemplary embodiment, as an example, when the receiving section 52 has received the operation instruction for heating, the drive control section 54 sets the temperature of the air to be discharged by the air conditioning section 40 to maximum. Further, as an example, when the receiving section 52 has received the operation instruction for heating, the drive control section 54 sets a blowing amount of the air to be discharged from the air ejection port to maximum.

Furthermore, when the receiving section 52 has received the operation instruction for heating, the drive control section 54 controls the electric register 42 such that a wind direction of the air to be discharged from the air ejection port is directed toward the seatback 24. It should be noted that, in a case in which the air conditioning section 40 is capable of being set to plural operation modes, such as, for example, a face mode in which the air to be discharged from the air ejection port is directed toward a position of a face or a chest of the occupant seated at the vehicle seat 20, a foot mode in which the air to be discharged from the air ejection port is directed toward a foot of the occupant, or the like, the drive control section 54 sets the air conditioning section 40 to the face mode.

Further, when the receiving section 52 has detected boarding of the vehicle 10 by the occupant, the drive control section 54 performs control to switch from operation of the seat ventilation 32 to operation of the seat heater 34.

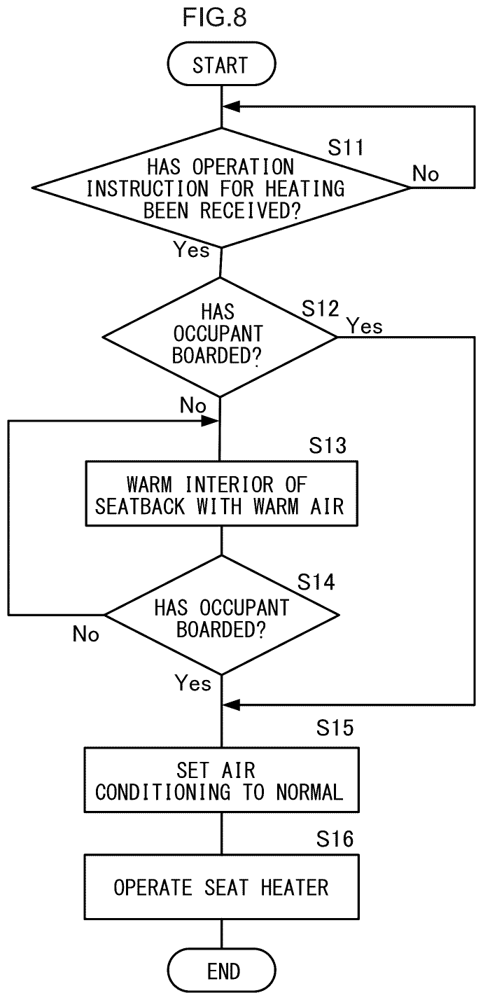

Next, a series of processing executed at the vehicle ECU 50 will be explained using the flowchart illustrated in FIG. 8. It should be noted that processing that is executed at the vehicle ECU 50 is executed due to the CPU 50A reading out a program from the ROM 50B or the storage 50D, and expanding and executing the program in the RAM 50C.

As illustrated in FIG. 8, first, at step S11, the receiving section 52 determines whether or not an operation instruction for heating by the air conditioning section 40 has been received prior to boarding by an occupant. In a case in which an operation instruction for heating has not been received (step S11), the receiving section 52 repeats the processing of step S11 until an operation instruction for heating has been received. In a case in which the receiving section 52 has received an operation instruction for heating at step S11 (YES at step S11), the receiving section 52 determines whether or not boarding of the vehicle 10 by the occupant has been detected at step S12.

When it is determined, at step S12, that the occupant has not boarded (NO at step S12), at step S13, the drive control section 54 causes the interior of the seatback 24 to be warmed with warm air by the air conditioning section 40 and the seat ventilation 32. Specifically, the drive control section 54 sets the temperature and the blowing amount of the air to be discharged from the air ejection port by the air conditioning section 40 to maximum, and causes warm air at the temperature that has been set to be discharged into the vehicle cabin from the air ejection port at the maximum blowing amount. Further, the drive control section 54 controls the electric register 42 such that the wind direction of the air to be discharged from the air ejection port is directed toward the seatback 24. Then, the drive control section 54 operates the seat ventilation 32 to cause warm air that has been discharged into the vehicle cabin to be sucked into the interior of the seatback 24.

Next, at step S14, the receiving section 52 determines whether or not boarding of the vehicle 10 by the occupant has been detected. In a case in which the occupant has not boarded at step S14 (NO at step S14), the vehicle ECU 50 transitions the processing to step S13, and the drive control section 54 continues to cause the interior of the seatback 24 to be warmed with warm air by the air conditioning section 40 and the seat ventilation 32.

On the other hand, in a case in which the occupant has boarded at step S12 (YES at step S12), or in a case in which the occupant has boarded at step S14 (YES at step S14), the vehicle ECU 50 transitions the processing to step S15.

At step S15, the drive control section 54 sets air conditioning by the air conditioning section 40 to normal. Specifically, the drive control section 54 returns the temperature and the blowing amount of the air to be discharged from the air ejection port by the air conditioning section 40, which were set to maximum, to original setting values. Further, the drive control section 54 controls the electric register 42 such that the wind direction of the air to be discharged from the air ejection port is returned from the wind direction directed toward the seatback 24 to an original wind direction.

Next, at step S16, the drive control section 54 stops operation of the seat ventilation 32, and operates the seat heater 34. Namely, the drive control section 54 switches from operation of the seat ventilation 32 to operation of the seat heater 34, and the vehicle ECU 50 ends the series of processing.

### Operation and Effects

Next, operation and advantageous effects of the present exemplary embodiment will be explained.

In the vehicle 10 according to the present exemplary embodiment, in a case in which the receiving section 52 has received an operation instruction for heating by the air conditioning section 40 prior to boarding by an occupant, the drive control section 54 causes warm air to be discharged into the vehicle cabin by the air conditioning section 40, and causes warm air to be sucked in by the seat ventilation 32. Thus, the interior of the seatback 24 can be warmed by sucking in warm air resulting from heating, at the seat ventilation 32, prior to boarding by the occupant, and therefore, temperature reduction of the vehicle seat 20 when the occupant is seated can be suppressed. Consequently, reduction in comfort of the occupant when seated at the vehicle seat 20 can be suppressed.

Further, in the vehicle 10 according to the present exemplary embodiment, since the seat heater 34 is operated when the occupant boards the vehicle, the seatback 24 is warmed by the seat heater 34, whereby comfort of the occupant when the occupant is seated at the vehicle seat 20 can be further improved.

Furthermore, in the vehicle 10 according to the present exemplary embodiment, in a case in which the receiving section 52 has received operation instruction for heating by the air conditioning section 40 prior to boarding by the occupant, the drive control section 54 controls the electric register such that the wind direction of the warm air is directed toward the vehicle seat, and therefore, the interior of the seatback 24 can be warmed more efficiently.

Further, in the vehicle 10 according to the present exemplary embodiment, in a case in which the receiving section 52 has received operation instruction for heating by the air conditioning section 40 prior to boarding by the occupant, the drive control section 54 sets at least one of the blowing amount or the temperature of the air conditioning section 40 to maximum, and therefore, the interior of the seatback 24 can be warmed more efficiently.

Furthermore, in the vehicle 10 according to the present exemplary embodiment, in a case in which the receiving section 52 has detected boarding of the vehicle by the occupant, since the drive control section 54 returns the blowing amount and the temperature of the warm air to normal, a setting operation by the occupant when the occupant has boarded can be made unnecessary, and an excessive blowing amount and an excessively high temperature can be prevented to thereby ensure comfort of the occupant.

### Notes

It should be noted that, in the exemplary embodiment described above, although the drive control section 54 sets the temperature of the air to be discharged by the air conditioning section 40 and the blowing amount of the air to be discharged from the air ejection port to maximum when the receiving section 52 has received an operation instruction for heating, the present disclosure is not limited thereto. Only the temperature of the air to be discharged by the air conditioning section 40 may be set to maximum, or only the blowing amount of the air to be discharged from the air ejection port may be set to maximum.

Further, in the exemplary embodiment described above, although the vehicle 10 is provided with the electric register 42, the present disclosure is not limited thereto, and it is not necessary for the electric register 42 to be provided.

Furthermore, in the exemplary embodiment described above, although the vehicle 10 is provided with the seat heater 34, the present disclosure is not limited thereto, and it is not necessary for the seat heater 34 to be provided.

Further, in the exemplary embodiment described above, although the vehicle 10 is provided with the seat heater 34 at the seatback 24, the present disclosure is not limited thereto, and the seat heater 34 may be further provided at the seat cushion 22.

Furthermore, in the exemplary embodiment described above, although the seat ventilation 32 is installed at the interior of the seatback 24, the present disclosure is not limited thereto. The seat ventilation 32 may be provided at any location as long as air can be sucked into the interior of the seatback 24.

Further, in the exemplary embodiment described above, although the vehicle 10 is provided with the seat ventilation 32 at the seatback 24, the present disclosure is not limited thereto, and the seat ventilation 32 may be provided at the seat cushion 22 or may be provided at the seat cushion 22 and the seatback 24.

Furthermore, the configuration of the present disclosure is not limited to the above exemplary embodiment, and the configuration can be modified as appropriate as long as the problem can be solved.

What is claimed is:

1. A vehicle comprising:
a vehicle seat, the vehicle seat having, at a surface thereof, a hole communicating with an interior thereof, an occupant being able to sit at the vehicle seat;
seat ventilation, the seat ventilation being configured to suck air into the interior of the vehicle seat;
an air conditioning section, the air conditioning section being configured to discharge warm air or cold air into a vehicle cabin to adjust a temperature within the vehicle cabin;
a receiving section, the receiving section being configured to receive an operation instruction for heating by the air conditioning section prior to boarding by the occupant; and
a drive control section, the driving control section, in a case in which the operation instruction for heating has been received, being configured to cause warm air to be discharged into the vehicle cabin by the air conditioning section, and to cause the warm air to be sucked in by the seat ventilation.

2. The vehicle according to claim 1, further comprising a seat heater, the seat heater being configured to warm a surface of the vehicle seat on a side at which the occupant sits,
wherein, in a case in which boarding of the vehicle by the occupant has been detected, the drive control section switches from operation of the seat ventilation to operation of the seat heater.

3. The vehicle according to claim 1, further comprising an electric register, the electric register being capable of electrically changing a wind direction of the warm air and the cold air,
wherein, in a case in which the operation instruction for heating has been received, the drive control section controls the electric register such that the wind direction is directed toward the vehicle seat.

4. The vehicle according to claim 1, wherein, in a case in which the operation instruction for heating has been received, the drive control section sets at least one of a blowing amount or a temperature of the air conditioning section to maximum.

5. The vehicle according to claim 4, wherein, in a case in which boarding of the vehicle by the occupant has been detected, the drive control section returns the blowing amount and the temperature of the air conditioning section to normal.
